(19) United States
(12) Patent Application Publication
(10) Pub. No.: US 2020/0173393 A1
(43) Pub. Date: Jun. 4, 2020

(54) PISTON FOR A RECIPROCATING-PISTON INTERNAL COMBUSTION ENGINE, AND RECIPROCATING-PISTON INTERNAL COMBUSTION ENGINE

(71) Applicant: Volkswagen Aktiengesellschaft, Wolfsburg (DE)

(72) Inventors: Paulo Ivan URZUA TORRES, Wolfsburg (DE); Martin BIER, Meinersen (DE)

(73) Assignee: Volkswagen Aktiengesellschaft, Wolfsburg (DE)

(21) Appl. No.: 16/786,577

(22) Filed: Feb. 10, 2020

Related U.S. Application Data
(63) Continuation of application No. PCT/EP2018/069987, filed on Jul. 24, 2018.

(30) Foreign Application Priority Data
Aug. 8, 2017 (DE) 10 2017 213 831.9

(51) Int. Cl. F02F 3/10

(52) U.S. Cl. CPC F02F 3/10

(57) ABSTRACT

A piston for a reciprocating-piston internal combustion engine, having a ring carrier with an outer piston crown and an inner piston crown, and comprising a piston skirt extending from the inner piston crown in the axial direction, the piston skirt having at least one at least partially arcuately formed guide surfaces, the at least one guide surface being disposed in the arcuately formed area at a distance from the ring carrier, which is adjacent in the axial direction, in such a way that a gap results between the ring carrier and the guide surface, the piston skirt and the ring carrier being connected to each other via at least one reinforcing rib, which extends transversely over the inner piston crown.

This nonprovisional application is a continuation of International Application No. PCT/EP2018/069987, which was filed on Jul. 24, 2018, and which claims priority to German Patent Application No. 10 2017 213 831. 9, which was filed in Germany on Aug. 8, 2017, and which are both herein incorporated by reference.

### BACKGROUND OF THE INVENTION

### Field of the Invention

The present invention relates to a piston for a reciprocating-piston internal combustion engine as well as a to a reciprocating-piston internal combustion engine comprising a piston of this type, in particular for use in motor vehicles. In this respect, reference is also explicitly made to motor vehicles having reciprocating pistons of this type.

### Description of the Background Art

A piston for an internal combustion engine is known from DE 10 2015 201 633 A1, which corresponds to U.S. Pat. No. 10,436,146, in which the piston has a ring carrier referred to as a ring zone and a piston skirt referred to as a shaft. To save weight, this piston has openings between the ring zone and the shaft, which extend from the piston outside to the piston inside. To achieve a sufficient rigidity, despite the openings, the shaft is additionally connected to the ring carrier via a central rib, which is disposed between the openings.

### SUMMARY OF THE INVENTION

It is therefore an object of the present invention to provide a piston for a reciprocating-piston internal combustion engine as well as a reciprocating-piston internal combustion engine, which are thermally functionally improved with a sufficient rigidity, and which have a low weight.

A piston according to the invention for a reciprocating-piston internal combustion engine comprises a ring carrier with an outer piston crown and an inner piston crown. The side facing a combustion chamber and immediately delimiting it in the installed state of the piston is referred to as the outer piston crown. The opposite side of the piston crown, which faces away from the combustion chamber in the installed state, is referred to as the inner piston crown. A piston skirt which has at least one at least partially arcuately formed guide surface, extends from the inner piston crown in the axial direction of the piston. In particular, the piston skirt may have two guide surfaces, each extending over one curve segment, viewed in the circumferential direction of the piston, for example, on opposite sides of the piston. In the case of the piston according to the invention, the at least one guide surface is disposed in the arcuately formed area at a distance from the ring carrier, which is adjacent in the axial direction, such that a gap results between the ring carrier and the guide surface. A direct heat transfer from the ring carrier to the arcuate areas is avoided thereby, which is thermally advantageous. The piston skirt and the ring carrier are furthermore connected to each other via at least one reinforcing rib, which extends transversely over the inner piston crown. In particular, an indirect connection between a piston crown of the ring carrier and a piston skirt is meant thereby, such that at least one reinforcing rib (in particular two or more reinforcing ribs) extend transversely over the piston crown, and one element or multiple elements of a piston skirt extend(s) from the (particular) reinforcing rib, in particular (at least) one piston pin boss and at least one guide surface In this case, the part of the piston skirt having one or multiple guide surfaces and the ring carrier may be connected to each other only indirectly via the reinforcing rib. A partially great rigidity of the piston may be achieved in a material-minimizing manner with the aid of at least one reinforcing rib of this type, while simultaneously achieving advantageous thermal properties and low component weight. It has been shown that the thermal decoupling achieved with the aid of the piston according to the invention is so good that the piston thermal clearance essentially corresponds to the piston installation clearance, i.e. only slight relative changes with respect to the clearance between the piston and the cylinder wall take place in the entire characteristic map and temperature range of a reciprocating-piston internal combustion engine. The installation clearance and the piston impact pulse resulting therefrom may be minimized thereby. This also results, among other things, in an acoustically unobtrusive reciprocating-piston internal combustion engine having only a low noise development. Moreover, a tilting of the piston may be reduced to a minimum, which also results in a lower oil consumption.

The aforementioned gap between the guide surface and the ring carrier is, in particular, a continuous gap, i.e. it extends over the entire arcuate guide surface in each case. In other words, the guide surface is separated from the ring carrier by the gap over its entire arcuate extension.

If multiple guide surfaces are provided, a corresponding gap is preferably formed between each guide surface and the ring carrier, so that no direct connection exists between the guide surfaces and the ring carrier in the axial direction. The guide surfaces are then thermally decoupled from the ring carrier, at least to the extent that a direct heat transfer is prevented. This is advantageous, in particular in view of the fact that the guide surfaces heat up due to the heat occurring in the area of the ring carrier, which may result in an increased friction between the guide surfaces and the cylinder wall due to thermal expansion, in particular if the heating of the guide surfaces and the cylinder wall takes place at different rates and/or if the expansion takes place to different degrees due to different materials and different coefficients of thermal expansion. This may result in a piston overlap (i.e. in that the piston diameter becomes larger than the cylinder diameter), even resulting, in extreme cases, in a so-called “piston seizure” or a jamming of the piston in the cylinder.

A reinforcing rib extending transversely over the inner piston crown, in the present case, is meant to be, in particular, a reinforcing rib which extends transversely from an outer point of the piston crown to another outer point of the piston crown. It is preferred if the reinforcing rib is fixedly connected to the inner piston crown over a large part of this extension length transversely over the inner piston crown, preferably over the entire extension length. A particularly secure secant-like connection of the reinforcing rib to the piston may thus be implemented, and a rigid structure may be generated as a whole.

The reinforcing rib extends in this respect over the inner piston crown, in particular in a secant-like manner. The term “secant-like” is intended to express the fact that the reinforcing rib is not limited to linear reinforcing rib designs between two outer points of the circumference. Within the meaning of the invention, reinforcing ribs are also viewed as secant-like reinforcing ribs, which have an arcuate or otherwise bent progression, for example a zigzag-like progression. The thickness extending transversely to the extension direction of the reinforcing rib and the height of the reinforcing rib(s) may also vary. However, the length of the reinforcing rib extending transversely through the piston crown is greater than the width and/or the height of the reinforcing rib extending in the axial direction of the piston.

It has been shown that a piston according to the invention may be constructed with little material use, if necessary with high rigidity and nevertheless with low weight, saving material, due to the combination of the at least one gap between the guide surface(s) and the ring carrier, on the one hand, (in particular two gaps between one guide surface and the ring carrier in each case) and the formation of the at least one reinforcing rib extending transversely over the inner piston crown, on the other hand, (in particular two reinforcing ribs, one reinforcing rib being assigned to one guide surface in each case). It has been shown that the design according to the invention even permits the manufacture and use of a particularly weight-reduced piston made from aluminum. It is particular preferred if the piston according to the invention is manufactured as a single piece from aluminum.

In a practical specific embodiment of a piston according to the invention, the at least one reinforcing rib extends outwardly from the inner piston crown in the axial direction in a middle section to the extent that a piston pin boss is formed in the reinforcing rib. In particular, the area within two oppositely disposed guide surfaces is designated the middle section.

Two or more reinforcing ribs, in particular two reinforcing ribs formed in parallel to each other, preferable extend in the axial direction to the extent that a piston pin boss is formed in each case in these reinforcing ribs themselves. When the piston is used in a reciprocating-piston internal combustion engine, forces are transferred from the piston to a connecting rod via the piston pin boss, in particular via an inserted piston pin, for the purpose of driving a crankshaft in the known manner. A material-saving yet simultaneously rigid overall structure may be achieved by a reinforcing rib, two reinforcing ribs or more reinforcing ribs, with the aid of which the piston is well guided within the cylinder even at high piston forces, whereby a low-loss force transmission is made possible.

The piston skirt is connected to the ring carrier, in particular via the at least one reinforcing rib. In addition, a connecting section or multiple connecting sections may be provided, which are also connected to the ring carrier. In this regard, reference is made, in particular, to a design, in which two oppositely disposed guide surfaces are connected to each other via two connecting sections to form a frame-like structure, and the connecting sections are each at least partially connected to the inner piston crown. The connecting sections may extend transversely over the diameter of a piston, in particular pass a piston pin boss. If the ring carrier, in particular the inner piston crown of the ring carrier, is additionally connected to one connecting section or two connecting sections, in particular in the area of piston pin bosses, the overall rigidity of the piston is further increased, or the loading of the reinforcing ribs may be reduced, so that a further weight optimization may take place due to a corresponding design of the reinforcing ribs. The connection may be implemented exclusively indirectly via another element, in particular via a reinforcing rib, and/or it may be directly implemented in that the connecting sections are at least partially connected directly to the piston crown. It is preferred if a connection of this type is limited to areas situated at a distance from the outer circumference of the piston, in particular to middle areas around a piston pin boss or around two or more piston pin bosses.

To keep the heat transfer between the ring carrier and the guide surfaces low and nevertheless achieve a good strength, the at least one connecting section is preferably connected to the inner piston crown over a smaller surface area than a corresponding reinforcing rib.

Alternatively or additionally, the connecting section is connected to the piston crown only in an inner area thereof, i.e. in an area at a distance from the outer circumference of the piston, in particular in an area which is situated in an indentation delimited by an annular outer edge within the outer edge of the inner piston crown.

Alternatively or additionally, the connecting section again extends, in particular, only over an area surrounding the piston pin boss, for example over a length which is slightly greater than the diameter of the piston pin boss, e.g. no more than 1.1 times, no more than 1.2 times or no more than 1.3 times the diameter of the piston pin boss, in particular such that the connecting section extends over the piston pin boss and projects over it on both sides at the same length.

The piston pin boss is surrounded, in particular, by bulge extending perpendicularly to the axial direction. The bulge is preferably part of the connecting section, which is connected to the inner piston crown. This results in a contact area which is limited in terms of surface area to the middle area of the piston crown—viewed in the radial direction—between the connecting section and the inner piston crown of the ring carrier, which is thermally advantageous.

As mentioned above, the connecting sections may be arranged, in particular, in such a way that a frame-shaped structure is formed from two oppositely disposed, arcuate guide surfaces and two oppositely disposed connecting sections. The two reinforcing ribs are each formed, in particular, on the inside of the connecting sections. Calculations have shown that, in this case, a particularly great rigidity of the piston is achieved with good thermal properties. After all, the forces acting upon the connecting sections, in particular, are reduced with the aid of the reinforcing ribs extending on the inside. A piston of this type may be particularly advantageously manufactured as a single piece from aluminum.

Additional weight savings may be achieved in connection with a piston according to the invention, if the ring carrier has an indentation or multiple indentations on the surface facing the piston skirt, i.e. in the area of the inner piston crown. An indentation of this type may be delimited, in particular, by an outer edge formed on the outside of the inner piston crown, preferably by an outer edge which has a uniform thickness over the entire circumference of the inner piston crown. One or multiple indentations may then extend within the outer edge. In other words, in the case of a piston according to the invention, the piston crown thickness may be reduced, in particular by forming indentations, and additional weight may thus be saved.

If the at least one reinforcing rib extends transversely through the indentation in such a way that it is connected in each case to the inner piston crown via a complete, secant-like section, i.e. if the secant-like section extends completely over two points of an outer edge, indentations correspondingly result on both sides of the reinforcing rib.

Two or more reinforcing ribs preferably extend transversely through the indentation, in particular completely in a secant-like manner.

By forming an indentation or multiple indentations, the thickness of the ring carrier extending in the axial direction is reduced, whereby material and weight of the piston are saved.

In another example embodiment, the at least one reinforcing rib and/or the at least one connecting section is/are provided with a partially curved design, viewed in the longitudinal direction (i.e. in its extension direction). The direction in which the reinforcing rib or the connecting section has the greatest extension transverse to the axial direction is referred to as the longitudinal direction, in particular the extension direction of a secant-like section, which extends transversely through the diameter of the piston.

In particular, the reinforcing rib and/or the at least one connecting section have/has an omega-shaped and/or arcuate and preferably outwardly curved course. An omega-shaped and/or arcuate, in particular outwardly curved, course makes it possible to achieve an improved flexural rigidity of the reinforcing rib and the piston as a whole, in particular for absorbing forces which are to be transferred from the piston to a connecting rod via a piston pin.

The reinforcing rib can have a course, such that, in the area of the piston pin boss, the reinforcing rib transitions into a bulge surrounding the piston pin boss on the inside, viewed in the longitudinal direction, and is disposed at a distance from the connecting section in an outer area of the inner piston crown. The thickness of the reinforcing rib is preferably enlarged on the outside, i.e. in particular where the reinforcing rib approaches the outer edge of the inner piston crown and/or abuts the outer edge of the inner piston crown.

Two piston pin bosses are preferably provided on a piston according to the invention, each piston pin boss also extending through a reinforcing rib corresponding with this piston pin boss in each case. The connecting section and a corresponding reinforcing rib furthermore preferably form a unit in the area of the piston pin boss, i.e. the piston pin boss extends seamlessly through the connecting section and the corresponding reinforcing rib. Forces which are transferred between the piston and a connecting rod via a piston pin are thus distributed to the connecting section and the corresponding reinforcing rib, which provide a shared hollow cylindrical bearing surface for the piston pin in each case.

On the outside of a piston pin boss or each piston pin boss—and optionally also on the inside—a bulge protruding in the pass-through direction of the piston pin can extend over the full circumference of the piston pin boss in each case. The bulge preferably extends from a middle section of the inner piston crown and is further preferably formed around the piston pin boss, in particular in the shape of a circle arc. A bulge of this type makes it possible to additionally reinforce the area of the piston pin boss, on the one hand, and to enlarge middle connecting areas of connecting sections, on the other hand.

Further weight savings may be achieved if the at least one guide surface of the piston according to the invention has at least one recess, which reduces the guide surface to two or more partial guide surfaces. In principle, weight may be saved on each guide surface of a piston if less material is necessary by forming one or multiple recesses (e.g. in the form of indentations, notches, etc.). However, it has been proven to be particularly advantageous to form a large first guide surface without recess(es) in such a way that the occurring guide forces may be absorbed, and to provide a second guide surface, which is subjected to a smaller load due to its arrangement in a cylinder, with one or multiple recesses to further reduce the weight. In this respect. the one recess or multiple recesses should cause the guide surface to be divided into partial guide surfaces, which in sum are smaller than an opposite guide surface.

In particular, reference is made to the possibility of reducing the size of a guide surface by forming two partial guide surfaces, in that an upper first partial guide surface, disposed closer to the inner piston crown, and a lower partial guide surface, situated farther away from the inner piston crown, are formed. Partial guide surfaces of this type may be formed, in particular, on the so-called minor thrust face of a reciprocating-piston internal combustion engine, which is subjected to a smaller load in the installed state of the piston. The upper partial guide surface is preferably larger than the lower partial guide surface.

The invention also relates to a reciprocating-piston internal combustion engine comprising a piston as described above. In particular, the invention relates to an internal combustion engine comprising a piston, at least one guide surface having at least one recess, which reduces the guide surface into two partial guide surfaces. The partial guide surfaces are arranged in such a way that they are disposed on the minor thrust face. The minor thrust face is referred to as the side of a piston on which the piston does not rest during the expansion phase after passing through the top dead center. The side of the cylinder on which the piston having the guide surface rests during the expansion phase after the bottom dead center is referred to as the major thrust face. Higher forces usually take effect between the cylinder wall and the piston on the major thrust face.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an exemplary embodiment of a piston according to the invention in a perspective view;

FIG. 2 shows the piston from FIG. 1 in a side view according to arrow II from FIG. 1;

FIG. 3 shows the piston from FIGS. 1 and 2 in a longitudinal section according to section line III-III from FIG. 1;

FIG. 4 shows the piston from FIGS. 1 through 3 in a view from below according to arrow IV from FIG. 1;

FIG. 5 shows an exemplary embodiment of a piston according to the invention in a perspective view at an angle from below;

FIG. 6 shows the piston from FIG. 5 in a side view similar to arrow II from FIG. 1;

FIG. 7 shows the piston from FIGS. 5 and 6 in a longitudinal section according to section line III-III from FIG. 1; and

FIG. 8 shows a reciprocating-piston internal combustion engine comprising a piston according to the invention disposed therein in a schematic illustration.

### DETAILED DESCRIPTION

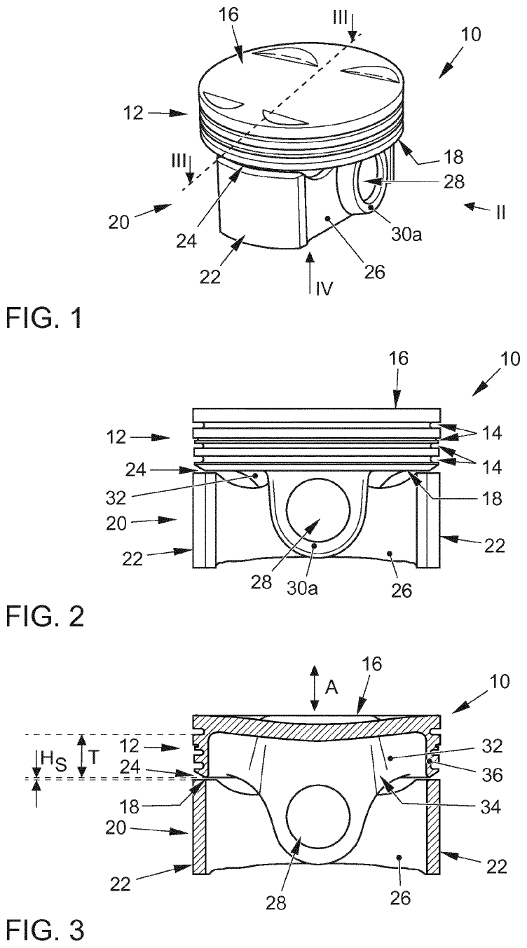

A piston 10 according to the invention is first described in connection with FIGS. 1 through 4. In the exemplary embodiment, illustrated piston 10 is manufactured as a single piece from aluminum. Alternatively, however, it may also be manufactured in multiple parts. Independently thereof, it may alternatively or additionally also be manufactured from other materials, e.g. from steel materials.

Piston 10 comprises a ring carrier 12, which in this specific embodiment includes a total of four indentations in the form of grooves 14, which extend over the outer circumference of ring carrier 12. Three of these grooves 14—the first (topmost), the third and the fourth (bottommost)—are so-called annular grooves, which are used to arrange piston rings (not illustrated) and/or other sealing elements (cf. FIG. 2). Second illustrated groove 14, which has a smaller radial depth than the other grooves, is an optional relieving groove. Ring carrier 12 has an outer piston crown 16, which is oriented toward and delimits a combustion chamber in the installed state of piston 10 in a reciprocating-piston internal combustion engine. An inner piston crown 18 is formed on the side opposite outer piston crown 16, which faces away from the combustion chamber in the installed state of piston 10 in a reciprocating-piston internal combustion engine.

As is clearly apparent in FIGS. 1 through 3, a piston skirt 20 extends from inner piston crown 18 in the axial direction of piston 10. Piston skirt 20 includes two guide surfaces 22 situated opposite each other and each extending over an arc section, viewed in the circumferential direction of piston 10. Guide surfaces 22 in the present case each extend over one arc section of approximately 60°. As is clearly apparent in FIGS. 2 and 3, guide surfaces 22 do not touch inner piston crown 18, because guide surfaces 22 are designed in such a way that a continuous gap 24 is formed between guide surfaces 22 and inner piston crown 18. Height Hₛ of gap 24 in the present case is approximately 1 mm to 2 mm, viewed in axial direction A (cf. FIG. 3).

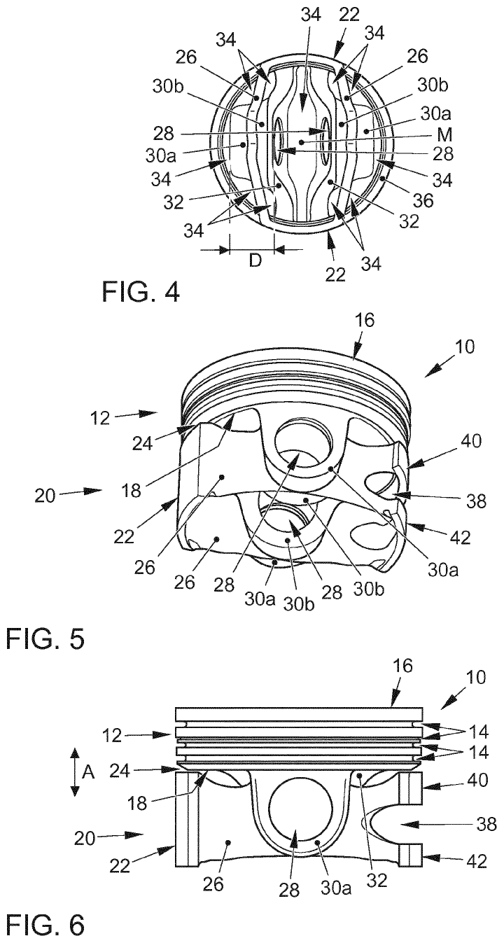

Guide surfaces 22 situated opposite each other are connected by two connecting sections 26, which each extend between guide surfaces 22. Connecting sections 26 extend between the outer ends of guide surfaces 22 in each case, viewed in the circumferential direction. Connecting sections 26 extend essentially in parallel to each other and at a distance from center point M of inner piston crown 18. As is clearly apparent in FIG. 4, connecting sections 26 are arcuately formed and are curved toward the outside. As is also clearly apparent in FIG. 4, the two guide surfaces 22 and connecting sections 26 extending between guide surfaces 22 form a frame-shaped structure.

Piston pin bosses 28, which have a circular cross section and are used to insert a piston pin (not illustrated), are formed in connecting sections 26. An outer bulge 30a and an inner bulge 30b are formed on the outside and inside of piston pin bosses 28 in each case, starting from connecting sections 26. Bulges 30a, 30b extends from a middle section of inner piston crown 18 over the full circumference of circular piston pin boss 28.

Connecting sections 26 are connected to inner piston crown 18 only in a middle area, which extends in each case over piston pin bosses 28 and bulges 30a, 30b.

Two reinforcing ribs 32 are also formed on piston 10, which—as is clearly apparent in FIG. 4—extend transversely over inner piston crown 18. A reinforcing rib 32 of this type is clearly apparent in the sectional representation in FIG. 3. It is also clearly apparent that reinforcing rib 32 is connected to inner piston crown 18 over its entire extension in its longitudinal direction. In the illustrated exemplary embodiment, the height of reinforcing rib 32 extending in axial direction A approximately corresponds to depth T of the indentation in the section adjacent to an outer edge 36 of inner piston crown 18, so that reinforcing rib 32 transitions into outer edge 36 on the outside.

As is apparent in FIG. 4, reinforcing ribs 32 have an omega-shaped progression in the extension direction, and they are curved to the outside in a middle area in each case. The two reinforcing ribs 32 are formed mirror-symmetrically with respect to each other in relation to a mirror axis running through center point M. Reinforcing ribs 32 have a greater thickness in the outer areas adjacent to outer edge 36. In the exemplary embodiment, the thickness of reinforcing ribs 32 in the outer sections is approximately 9 mm with a piston diameter between 70 mm and 80 mm. The thickness of reinforcing ribs 32 in the outer areas is preferably between 5 percent and 30 percent of the piston diameter, particularly preferably between 10 percent and 20 percent.

The piston diameter of a piston 10 according to the invention is preferably between 40 mm and 200 mm, more preferably between 60 mm and 150 mm and particularly preferably between 80 mm and 120 mm.

Reinforcing ribs 32 are formed on the inside of connecting sections 26 and are oriented essentially in parallel to connecting sections 26. In a middle area, reinforcing ribs 32 and inner bulge 30b each form a unit, i.e. they are connected directly to each other so that a continuous piston pin boss 28 having a hollow cylindrical shape is formed on the inside. In the illustrated specific embodiment, these units each have a thickness D of approximately 20 percent of the piston diameter. Thickness D is preferably around 10 percent to 30 percent of the piston diameter.

In the outer areas, reinforcing ribs 32 are formed at a distance from connecting sections 26. Reinforcing ribs 32 are also situated at a distance from center point M of inner piston crown 18.

Ring carrier 12 has indentations 34 on the surface facing piston skirt 20. Indentations 34 are formed on the inside of circular outer edge 36, which extends on the outside over the entire circumference of piston 12 and has a constant thickness, Indentations 34 are separated from each other by reinforcing ribs 32 and connecting sections 26. As is apparent in FIG. 4, this results in a total of seven areas with indentations 34, taking into account the fact that indentations 34 marked by two contiguous arrows in each case also extend over the particular area which, in FIG. 4, is covered by the outer area of connecting section 26 in each case. Only one contiguous indentation 34 is therefore marked in each case by the contiguous arrows.

The shape and geometry of reinforcing ribs 32 are clearly apparent in FIG. 3 in a view perpendicular to the extension direction of reinforcing ribs 32. Reinforcing rib 32 extends on the outside from the inside of outer edge 36 within indentation 34 in the transverse direction in each case and is provided with a arcuate shape therebetween, such that piston pin boss 28 is enclosed, so that piston pin boss 28 also extends through reinforcing rib 32.

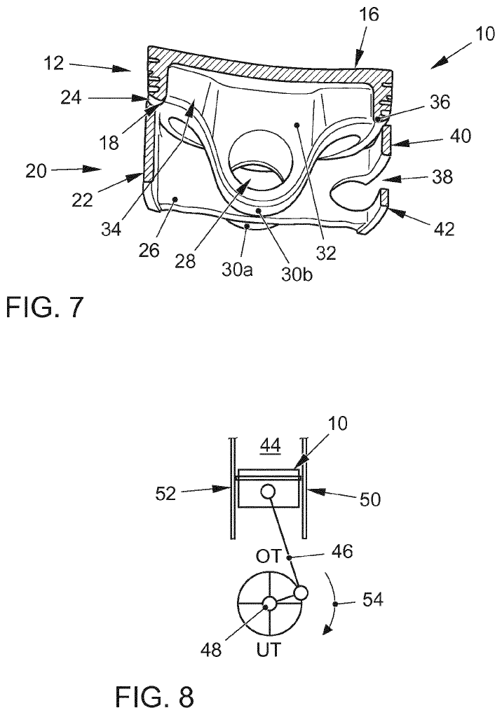

An exemplary embodiment of a piston 10 is illustrated in FIGS. 5 through 7. To describe the second specific embodiment, the same reference numerals are used for identical or at least functionally equivalent elements as in describing the first specific embodiment. Unless otherwise described or shown, piston 10 according to the second specific embodiment according to FIGS. 5 through 7 is provided with a design identical to piston 10 in the first specific embodiment according to FIGS. 1 through 4. Only the differences between the second specific embodiment and the first specific embodiment are discussed below.

Piston 10 in the second specific embodiment also has a ring carrier 12 and a piston skirt 20 extending therefrom in the axial direction, including two guide surfaces 22 extending over an arc section. One of guide surfaces 22 in the present case is divided by a recess 38 into two partial guide surfaces 40, 42, namely an upper partial guide surface 40, which is disposed closer to inner piston crown 18, and a lower partial guide surface 42, which is situated farther away from inner piston crown 18. Upper partial guide surface 40 has a greater height extending in the axial direction than lower partial guide surface 42. The height of recess 38 extending in the axial direction corresponds approximately to the height of upper partial guide surface 40 in the illustrated exemplary embodiment.

A reciprocating-piston internal combustion engine comprising a combustion chamber 44 in the form of a cylinder and a piston 10 disposed therein is illustrated schematically in FIG. 8. Piston 10 is connected to a crankshaft 48 with the aid of a connecting rod 46. Piston 10 according to the second specific embodiment described above is disposed in combustion chamber 44 in such a way that the guide surface with partial guide surfaces 40, 42 is disposed on a minor thrust face 50, and continuous guide surface 22 is disposed on a major thrust face 52. Major thrust face 52 corresponds to the side on which piston 10 rests with continuous guide surface 22 during the expansion phase after passing through the top dead center (TDC), i.e. the left side in FIG. 8, when crankshaft 48 rotates clockwise in the direction of arrow 54.

The features of the invention disclosed in the drawings and in the claims may be essential to implementing the invention in its various specific embodiments, both individually and in any combination. The invention may be varied within the scope of the claims and taking into account the knowledge of the competent person skilled in the art.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A piston for a reciprocating-piston internal combustion engine, the piston comprising:
a ring carrier with an outer piston crown and an inner piston crown; and
a piston skirt extending from the inner piston crown in an axial direction, the piston skirt having at least one at least partially arcuately shaped guide surface,
wherein the at least one guide surface is disposed in the arcuately shaped area at a distance from the ring carrier, which is adjacent in the axial direction, such that a gap is formed between the ring carrier and the guide surface, and
wherein the piston skirt and the ring carrier are connected to each other via at least one reinforcing rib that extends transversely over the inner piston crown.

2. The piston according to claim 1, wherein the at least one reinforcing rib extends from the inner piston crown in the axial direction in a middle section to the extent that a piston pin boss is formed in the reinforcing rib.

3. The piston according to claim 1, characterized in that the piston skirt is connected to the ring carrier via the at least one reinforcing rib and via one or multiple connecting sections between two guide surfaces.

4. The piston according to claim 1, wherein a frame-shaped structure is formed from two arcuate guide surfaces and two connecting sections extending between the guide surfaces, and wherein two reinforcing ribs are formed on an inside of the connecting sections.

5. The piston according to claim 1, wherein the ring carrier has an indentation on the surface facing the piston skirt, and wherein the at least one reinforcing rib extends transversely through the indentation such that it is connected on an outside to an inner surface of the indentation in each case.

6. The piston according to claim 1, wherein the at least one reinforcing rib and/or the at least one connecting section is/are provided with an at least partially curved design, viewed in a longitudinal direction.

7. The piston according to claim 1, wherein two piston pin bosses are provided, and the two piston pin bosses extend through a reinforcing rib corresponding to this piston pin boss.

8. The piston according to claim 1, wherein a bulge extending in the guide-through direction of a piston pin is formed on an outside of a piston pin boss and extends over the full circumference of the piston pin boss.

9. The piston according to claim 1, wherein the at least one guide surface has at least one recess, which reduces the guide surface to two or more partial guide surfaces.

10. A reciprocating-piston internal combustion engine comprising a piston according to claim 1.
